(19) United States
(12) Patent Application Publication
(10) Pub. No.: US 2019/0375396 A1
(43) Pub. Date: Dec. 12, 2019

(54) REGENERATION OF A PARTICULATE FILTER

(71) Applicant: Dr. Ing. h.c. F. Porsche Aktiengesellschaft, Stuttgart (DE)

(72) Inventor: Sven Cortes, Unlingen (DE)

(21) Appl. No.: 16/434,239

(22) Filed: Jun. 7, 2019

(30) Foreign Application Priority Data
Jun. 7, 2018 (DE) 10 2018 113 610.2

(51) Int. Cl. B60W 20/16; F01N 9/00; B60W 10/02

(52) U.S. Cl. CPC B60W 20/16; F01N 2900/10; B60W 10/02; F01N 9/002

(57) ABSTRACT

A method for regenerating a particulate filter (30) that is arranged in the exhaust train of an internal combustion engine (12) of a vehicle. The vehicle has a drive train (10) with the internal combustion engine (12) and a clutch unit (18), and the clutch unit (18) connects the internal combustion engine (12) in a separable manner to a transmission (20). The method includes switching off the internal combustion engine (12), and closing the clutch unit (18) with a slip.

### CROSS REFERENCE TO RELATED APPLICATION

This application claims priority under 35 USC 119 to German Patent Appl. No. 10 2018 113 610.2 filed on Jun. 7, 2018, the entire disclosure of which is incorporated herein by reference.

### BACKGROUND

### Field of the Invention

The invention relates to a method for regenerating a particulate filter that is arranged in the exhaust train of an internal combustion engine of a vehicle. The vehicle has a drive train with the internal combustion engine and a clutch unit connects the internal combustion engine in a separable manner to a transmission.

The invention also relates to a vehicle with a drive train comprising an internal combustion engine and a clutch unit to connect the internal combustion engine to a transmission. A particulate filter is arranged in the exhaust train of the internal combustion engine. A control unit for activating the internal combustion engine and the clutch unit also is designed to carry out a regeneration of the particulate filter.

### Related Art

Particulate filters in the exhaust gas flow of internal combustion engines are becoming increasingly important. This relates in particular to vehicles having gasoline engines, the exhaust gases of which contribute to the particulate matter pollution of the environment. Particulate filters can reliably remove even the smallest particulates of soot from the exhaust gas flow.

The particulates filtered out of the exhaust gas flow are deposited in the particulate filter and therefore reduce the effect of the particulates. Passive and active regeneration measures are carried out to eliminate an accumulation of particulates in the particulate filter and to ensure permanent efficient operation of particulate filters. Passive regeneration measures represent those drive train states that are present without functional interventions of the engine controller and provide the possibility for the particulate filter of burning off accumulated soot. Active regeneration measures refer to a forced burning off of soot in the particulate filter. Depending on degrees of freedom of the drive train, whether a conventional drive or hybrid drive, the possible drive trains and states arising therefrom differ.

Active regeneration measures for the particulate filter can be divided into two groups. The first group comprises measures for temperature increase in the particulate filter by increasing the exhaust gas enthalpy. This approach achieves a necessary activation energy for the oxidation of carbon that is present in the form of soot in the particulate filter. The second group comprises measures of providing reaction educts to a sufficient extent for the oxidation of carbon in the particulate filter. Carbon as a soot customarily is present sufficiently in the particulate filter. However, in the event of stoichiometric operation of the internal combustion engine, the exhaust gas may not have sufficient oxygen to oxidize the carbon. Additional oxygen is required in the particulate filter so that the particulate filter can regenerate.

In the prior art, oxygen is supplied to the particulate filter by air, and therefore oxygen is conveyed from the surroundings through the combustion chambers of the internal combustion engine and to the particulate filter in unfired thrust phases. Parallel hybrid vehicles provide oxygen in the particulate filter by the concept of an “internal combustion engine pump”, i.e. entrainment of the internal combustion engine with the clutch unit closed in electric driving phases. However, this reduces the available driving torque.

U.S. Pat. No. 6,195,985 discloses a method for reducing the pollutant emission of an internal combustion engine. The pollutant emissions in the first minutes of operation of an internal combustion engine also depend on the previous operation and switching-off process. The internal combustion engine and the catalytic converter are subjected to a cleaning or flushing phase before the engine is at a standstill. During this cleaning or flushing phase, the movement of the internal combustion engine continues to be maintained for a certain time either by firing or by external drive before the engine is at a standstill and the supply of fuel in at least individual cylinders of the internal combustion engine is interrupted at least temporarily and air is conveyed exclusively. Thus, remaining pollutants that have accumulated in the internal combustion engine are supplied to the catalytic converter, which still is at the operating temperature, and the catalytic converter is enriched with oxygen. For example, the internal combustion engine can be allowed to peter out, as a result of which the rotational speed thereof drops continuously from the beginning of the flushing process until the engine is at a standstill.

In view of the above, an object of the invention is a method for improved regeneration of a particulate filter and a vehicle for carrying out the method. The method and vehicle permit simple and efficient exhaust gas cleaning for the internal combustion engine on the basis of a reliable regeneration of the particulate filter.

### SUMMARY

One aspect of the invention relates to a method for regenerating a particulate filter that is arranged in the exhaust train of an internal combustion engine of a vehicle. The vehicle has a drive train with the internal combustion engine and a clutch unit that connects the internal combustion engine in a separable manner to a transmission. The invention comprises switching off the internal combustion engine, and closing the clutch unit with a slip.

The invention also relates to a vehicle with a drive train having an internal combustion engine and a clutch unit to connect the internal combustion engine to a transmission. A particulate filter is arranged in the exhaust train of the internal combustion engine, and a control unit activates the internal combustion engine and the clutch unit. The control unit also is designed to carry out the method.

The invention extends a petering out of the internal combustion engine after the internal combustion engine is switched off to bring about an increased supply of air to the particulate filter. This is achieved by the clutch unit adopting a state in which the clutch unit is closed partially and therefore torque is transmitted from the drive train via a driveshaft into the internal combustion engine depending on the slip. In the particulate filter, air therefore is conveyed in unfired thrust phases of the internal combustion engine for an extended period of time into the particulate filter so that the particulate filter can regenerate reliably. The improved regeneration of the particulate filter enables the exhaust gas cleaning to be carried out reliably.

The petering out of the internal combustion engine relates to a passive mode without combustion where kinetic energy of the engine or of a part of the drive train connected fixedly to the internal combustion engine moves the cylinder. This also is referred to as the internal combustion engine coasting to a stop or shutting down. Movement of the cylinders with a corresponding activation of inlet and outlet valves enables air to be conveyed to the particulate filter together with the oxygen required for regenerating the particulate filter.

The internal combustion engine may be a gasoline engine for the combustion of fuel with production of an ignition spark. The particulate filter correspondingly may be a gasoline particulate filter. Particulates are understood as essentially meaning soot particulates that are based on carbon and are formed during the combustion of fuel in the internal combustion engine and subsequently are filtered out of an exhaust gas flow in the particulate filter.

The particulate filter is arranged in the exhaust train of the internal combustion engine of the vehicle and, during the normal mode, has combustion gases from the internal combustion engine flowing therethrough. When the internal combustion engine is switched off, the generation of a combustion mixture and the combustion thereof is stopped. The internal combustion engine peters out without active braking in a spinning movement.

In a simple configuration, the drive train merely has the internal combustion engine and the clutch unit, which are connected to a driveshaft. In principle, the transmission also can be added to the drive train, with only the part as far as the transmission being considered here. The drive train may comprise other components, for example vibration dampers, further clutches and a starting-up element. Further details regarding the drive train are indicated below. In addition, a starter device acts on the drive train or directly on the internal combustion engine to start the internal combustion engine.

The clutch unit is designed to connect or to separate the internal combustion engine to or from the transmission, depending on the actuation. Separating the clutch unit interrupts the transmission of force between the internal combustion engine and the transmission. The clutch unit is designed to connect the internal combustion engine with a slip to the transmission, and therefore only a partial transmission of force takes place. The clutch unit can have a fixed operating mode with a specified slip, or can adjust the slip seamlessly. In principle, any desired type of clutches is possible, for example a frictionally locking separating clutch, as is widespread in hybrid vehicles, a transmission clutch, as is widespread in hybrid and conventionally driven vehicles, or a viscous clutch.

The method may comprise an additional step for activating the internal combustion engine to carry out a temperature increase in the particulate filter before the internal combustion engine is switched off. In addition to oxygen from the air supplied by the internal combustion engine, the regeneration of the particulate filter also requires thermal energy that is provided by heating the particulate filter. During operation, the particulate filter is heated by exhaust gases of the internal combustion engine. However, after starting the internal combustion engine, the temperature of the particulate filter can be too low for the regeneration. The internal combustion engine therefore can be activated to adapt the combustion in a targeted manner such that a temperature increase takes place in the particulate filter. For example, an activation with lambda-split, rich operation of the internal combustion engine, or other measures can bring about the desired temperature increase. As a result, the oxygen that is conducted by the internal combustion engine via the air into the particulate filter can be used efficiently for regenerating the particulate filter.

The method may comprise an additional step for checking a temperature of the particulate filter before the internal combustion engine is switched off. The step of closing the clutch unit with a slip takes place depending on the temperature of the particulate filter. In addition to oxygen from the air supplied by the internal combustion engine, the regeneration of the particulate filter additionally requires thermal energy that is provided by heating of the particulate filter. During operation, the particulate filter is heated by exhaust gases of the internal combustion engine. However, after starting the internal combustion engine, the temperature of the particulate filter may not be sufficient for the regeneration. In this case, either lower ventilation can be carried out by means of a greater slip, i.e. a smaller transmission of torque to the internal combustion engine, or no regeneration is carried out, i.e. the clutch unit is completely open.

The step for closing the clutch unit with a slip may comprise closing the clutch unit for transmitting 10% to 90% of a torque of the drive train to the internal combustion engine, preferably for transmitting 15% to 40% of the torque of the drive train to the internal combustion engine, particularly preferably for transmitting 20% to 30% of the torque of the drive train to the internal combustion engine. The slip enables the ventilation of the particulate filter to be carried out to meet requirements. The more the torque of the drive train is transmitted to the internal combustion engine, the longer the internal combustion engine will peter out and supply air to the particulate filter. In the event of too intensive ventilation of the particulate filter, too much energy would be applied for ventilating the particulate filter, and therefore the transmitted torque has to be limited.

The method may comprise a bite point adaptation of the clutch unit. If the torque transmitted by the clutch unit is directly dependent on the position of a clutch actuator actuating the clutch unit, in particular of a hydrostatic clutch actuator, to estimate the transmitted clutch torque, first the position of the clutch actuator relative to the possible path of movement of the clutch unit has to be known and, second, reference has to be made to a clutch characteristic of a clutch torque depending on the actuator position on the actuator path. The bite point constitutes a supporting point of the clutch characteristic. The bite point can be determined once for the operation and, during the operation, can be adapted to the changed clutch behavior, which is not constant because of various influencing factors, such as wear, readjustment of the clutch unit and temperature and aging processes. For example, a defective determination of a bite point can be corrected if a torque change of the clutch torque is monitored for an error and, if an error-effected monitored clutch torque is determined, a starting position of the bite point adaptation is lowered dynamically to a lower value.

The method may comprise monitoring an engine rotational speed and opening the clutch unit when an idling rotational speed is reached or when the internal combustion engine is at a standstill. The closing of the clutch unit with a slip therefore takes place until the idling rotational speed or the standstill is reached. The slip delays reaching the idling rotational speed or delays the standstill in comparison to a separated clutch unit and takes place in each case for an extended period of time. Depending on a specific use and design of the drive train of the vehicle, as long-lasting a ventilation of the particulate filter as possible can therefore take place.

The vehicle may have a measuring device for measuring a temperature of the particulate filter. The measuring device may be connected to the control unit to transmit the temperature to the control unit. In addition to oxygen from the air supplied by the internal combustion engine, the regeneration in the particulate filter additionally requires thermal energy that is provided by heating of the particulate filter. During operation, the particulate filter is heated by exhaust gases of the internal combustion engine. However, after starting the internal combustion engine, the temperature of the particulate filter may not be sufficient for the regeneration. By means of the measuring device, it can be ensured that the regeneration is carried out only when the particulate filter is at a sufficient temperature. Measures for actively increasing the temperature of the particulate filter before the internal combustion engine is switched off can also be carried out so that the particulate filter has a suitable temperature during the regeneration.

The drive train additionally may have an electric motor between the internal combustion engine and the transmission, and the clutch unit may be between the internal combustion engine and the electric motor. This is the case, for example, in a vehicle having a hybrid drive. The electric motor can act, for example, on a driveshaft shared with the internal combustion engine. An additional clutch device can be arranged between the electric motor and the transmission.

The drive train also may have a start-stop-on-the-move device between the internal combustion engine and the transmission, and the clutch unit may be between the internal combustion engine and the start-stop-on-the-move device. The start-stop-on-the-move device permits simple switching off and subsequent starting of the internal combustion engine. The start-stop-on-the-move device can comprise, for example, a mechanical flywheel that is connectable via the clutch unit to the internal combustion engine to start the internal combustion engine. The start-stop-on-the-move device permits complete shutting down of the internal combustion engine until the internal combustion engine is at a standstill.

The invention will be explained by way of example below using preferred exemplary embodiments with reference to the attached drawings, wherein the features illustrated below can constitute an aspect of the invention both individually in each case and in combination.

### BRIEF DESCRIPTION OF THE DRAWINGS

FIG. 1 is a schematic illustration of a drive train with an internal combustion engine, an electric motor and a clutch unit arranged in between, according to a first preferred embodiment, together with a particulate filter of the internal combustion engine and a control unit for activating the internal combustion engine.

FIG. 2 shows a flow diagram for carrying out a method for regenerating the particulate filter.

FIG. 3 shows various rotational speed profiles of the internal combustion engine from FIG. 1.

FIG. 4 shows various torque profiles of the clutch unit of FIG. 1 with the rotational speed profiles of the internal combustion engine of FIG. 2.

### DETAILED DESCRIPTION

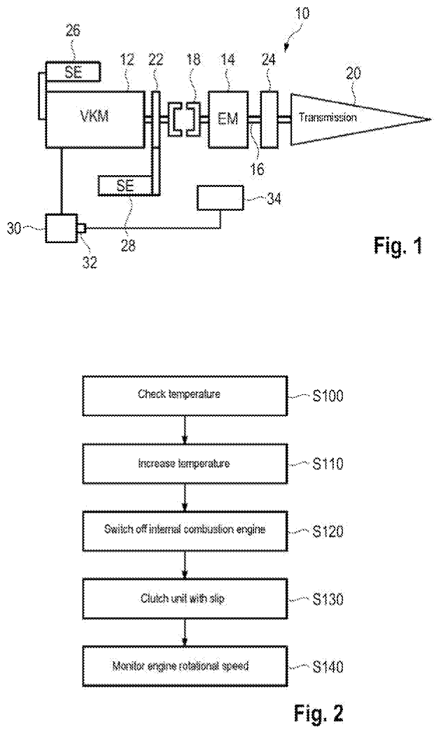

FIG. 1 shows a drive train 10 according to a first embodiment. The drive train 10 drives one or more axles of a vehicle.

The drive train 10 comprises an internal combustion engine 12 and an electric motor 14, which are arranged in order to transmit force to a driveshaft 16. The internal combustion engine 12 here is a gasoline engine for burning fuel after production of an ignition spark.

A clutch unit 18 is arranged between the internal combustion engine 12 and the electric motor 14. The force of the driveshaft 16 is converted via a transmission 20 and distributed.

The clutch unit 18 is designed to connect or to separate the internal combustion engine 12 to or from the electric motor 14 and the transmission 20 depending on actuation, with separation of the clutch unit 18 meaning an interruption to the force transmission. The clutch unit 18 is designed in such a manner that the force transmission can take place with a slip, and therefore only a partial force transmission takes place. The clutch unit 18 is designed here by way of example as a frictionally locking separating clutch, as a transmission clutch or as a viscous clutch.

The drive train 10 additionally comprises a vibration damper 22 and a starting element 24, which are arranged on the driveshaft 16. The vibration damper 22 is arranged between the internal combustion engine 12 and the clutch unit 18, while the starting element 24 is positioned between the electric motor 14 and the transmission 20.

The starting element 24 is a component which, in mechanical drives, sits in the torque flux between the motor/engine or the motors/engines and the transmission 20. The starting element 24 permits the transmission of torque at different rotational speeds. The starting element 24 can be designed as a classic disk clutch.

FIG. 1 additionally shows two starter devices 26, 28, of which a first starter device 26 acts directly on the internal combustion engine 12, and a second starter device 28 acts on the vibration damper 22.

A particulate filter 36 which is illustrated in FIG. 1 is connected downstream of the internal combustion engine 12. The particulate filter 30 is arranged in an exhaust train of the internal combustion engine 12. The particulate filter 30 is a gasoline particulate filter. Particulates are understood here as essentially meaning soot particulates which are based on carbon and are formed during the combustion of fuel in the internal combustion engine 12 and are subsequently filtered out of an exhaust gas flow in the particulate filter 30.

Combustion gases flow through the particulate filter 30 during the normal operation of the internal combustion engine 12. When the internal combustion engine 12 is switched off, the generation of a combustion mixture in the internal combustion engine 12, and the combustion of said combustion mixture are stopped. The internal combustion engine 12 peters out without active braking in a spinning movement. The petering out of the internal combustion engine 12 therefore relates to a passive mode without combustion, in which kinetic energy of the internal combustion engine 12 or of that part of the drive train 10 which is fixedly connected to the internal combustion engine 12 moves the cylinders thereof.

FIG. 1 furthermore shows a measuring device 32 for measuring a temperature of the particulate filter 30, which measuring device is designed here as a temperature sensor. The measuring device 32 is connected to a control unit 34 in order to transmit the measured temperature of the particulate filter 30 to said control unit. The control unit 34 here controls the internal combustion engine 12 and the clutch unit 18. Furthermore, the control unit 34 can also control the transmission 20 and the starting element 24.

A method for regenerating the particulate filter 30 will be described below with reference to FIG. 2. Individual method steps can be carried out here in different sequences, as emerges from the description below.

The method begins at step S100 with checking of the temperature of the particulate filter 30. The temperature is determined with the measuring device 32 and transmitted to the control unit 34.

In step S110, the internal combustion engine 12 is activated in order to carry out a temperature increase in the particulate filter 30. The control unit 34 has received a command to switch off the internal combustion engine 12 or determines itself that the internal combustion engine 12 should be switched off. Depending on the temperature of the particulate filter 30 that is determined in step S100, the control unit 34 determines whether the exhaust gases of the internal combustion engine 12 in the preceding operation have sufficiently heated the particulate filter 30 in order to carry out a regeneration in the particulate filter 30. Otherwise, the internal combustion engine 12 is activated, for example with lambda-split, a rich operation of the internal combustion engine 12, or other measures in order to adapt the combustion and to increase the temperature in the particulate filter 30.

In step S120, the internal combustion engine 12 is switched off at a time t0. A mixture is not prepared in the cylinders of the internal combustion engine 12, and generation of ignition sparks is stopped. During rotation of the driveshaft 16, air from the internal combustion engine 12 is conveyed to the particulate filter 30. The internal combustion engine 12 begins to coast to a stop.

In step S130, the clutch unit 18 is closed with a slip. The partial closing of the clutch unit also takes place at the time t0. In the present case, the slip results in a transmission of approximately 20% to 30% of the torque of the drive train 10 to the internal combustion engine 12. Instead of completely opening the clutch unit 18 in order not to transmit kinetic energy of the vehicle to the internal combustion engine 12, the internal combustion engine 12 is partially coupled up.

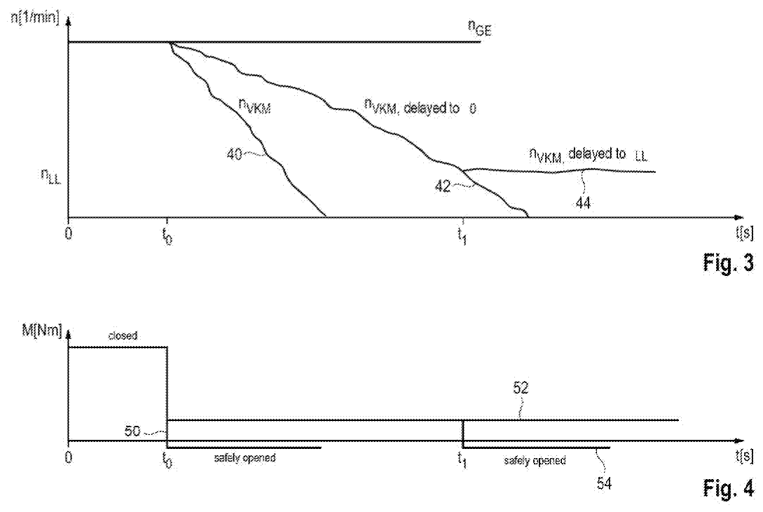

The same is illustrated in FIG. 3 in comparison to coasting of the internal combustion engine 12 to a stop without a slip, i.e. with the clutch unit 18 open. A resulting first rotational speed profile 40 corresponds to coasting of the internal combustion engine 12 to a stop with the clutch unit 18 completely open if, for example, the temperature of the particulate filter 30 is too low for regeneration. The rotational speed relatively rapidly drops after the time t0 in comparison with a second and third rotational speed profile 42, 44, in which the clutch unit 18 is in each case closed with a slip. The corresponding actuation of the clutch unit 18 emerges from FIG. 4. A first clutch actuating curve 50 shows that the clutch unit 18 is completely closed before the time t0 in accordance with the first rotational speed profile 40 and is then completely open. In accordance with the second and third rotational speed profiles 42, 44, the clutch unit 18 is completely closed before the time t0 and is then closed with a slip. This is shown in a second and third clutch actuating curve 52, 54 in FIG. 4.

While the internal combustion engine 12 is coasting to a stop, air is conveyed by the cylinders into the particulate filter 30, as a result of which the latter is regenerated. The ventilation of the particulate filter 30 is carried out here to meet requirements by adjusting the slip and depending on the temperature of the particulate filter 30. When more torque of the drive train 10 is transmitted to the internal combustion engine 12, the internal combustion engine 12 will peter out over a longer period and will supply air to the particulate filter 30.

Step S140 relates to monitoring of the engine rotational speed and to opening of the clutch unit 18 when an idling rotational speed or a standstill of the internal combustion engine 12 is reached. This differentiates the second and third rotational speed profiles 42, 44. The second rotational speed profile 42 shows the internal combustion engine 12 coasting as far as a standstill, while the third rotational speed profile 42 shows that, when an idling rotational speed is reached at a time t1 of the internal combustion engine 12, the clutch unit 18 is completely open, as the corresponding profiles of the second and third clutch actuating curve 52, 54 show.

### LIST OF REFERENCE SIGNS

Drive train 10
Internal combustion engine 12
Electric motor 14
Driveshaft 16
Clutch unit 18
Transmission 20
Vibration damper 22
Starting element 24
First starter device 26
Second starter device 28
Particulate filter 30
Temperature sensor 32
Control unit 34
First rotational speed profile 40
Second rotational speed profile 42
Third rotational speed profile 44
First clutch actuating curve 50
Second clutch actuating curve 52
Third clutch actuating curve 54

What is claimed is:

1. A method for regenerating a particulate filter that is arranged in the exhaust train of an internal combustion engine of a vehicle, the vehicle having a drive train with the internal combustion engine and a clutch unit, and the clutch unit connects the internal combustion engine in a separable manner to a transmission, the method comprising the steps switching off the internal combustion engine, and closing the clutch unit with a slip.

2. The method of claim 1, further comprising an additional step for activating the internal combustion engine to carry out a temperature increase in the particulate filter before the internal combustion engine is switched off.

3. The method of claim 1, further comprising checking a temperature of the particulate filter before the internal combustion engine is switched off, wherein the step of closing the clutch unit with a slip takes place depending on the temperature of the particulate filter.

4. The method of claim 1, wherein the step for closing the clutch unit with a slip comprises closing the clutch unit for transmitting 10% of 90% of a torque of the drive train to the internal combustion engine.

5. The method of claim 1, further comprising a step for bite point adaptation of the clutch unit.

6. The method of claim 1, further comprising monitoring an engine rotational speed and opening the clutch unit when an idling rotational speed is reached or when the internal combustion engine is at a standstill.

7. A vehicle comprising:
a drive train comprising an internal combustion engine and a clutch unit to connect the internal combustion engine to a transmission, and a particulate filter arranged in the exhaust train of the internal combustion engine, and a control unit for activating the internal combustion engine and the clutch unit, wherein the control unit is configured for closing the clutch unit with a slip when turning off the internal combustion engine.

8. The vehicle of claim 7, further comprising a measuring device for measuring a temperature of the particulate filter, wherein the measuring device is connected to the control unit to transmit the temperature to the control unit.

9. The vehicle of claim 8, characterized in that the drive train additionally has an electric motor between the internal combustion engine and the transmission, and the clutch unit being arranged between the internal combustion engine and the electric motor.

10. The vehicle of claim 9, wherein the drive train further has a start-stop-on-the-move device between the internal combustion engine and the transmission, and the clutch unit is between the internal combustion engine and the start-stop-on-the-move device.
